(19) United States
(12) Patent Application Publication
(10) Pub. No.: US 2014/0009929 A1
(43) Pub. Date: Jan. 9, 2014

(54) LAMP WITH A TRANSLUCENT PLASTIC ELEMENT

(71) Applicant: Flextronics Automotive GmbH & Co KG, Fickenhausen (DE)

(72) Inventors: Frank Wimbert, Owen (DE); Philip Hupfer, Burgthann (DE)

(73) Assignee: Flextronics Automotive GmbH & Co KG, Fickenhausen (DE)

(21) Appl. No.: 13/757,357

(22) Filed: Feb. 1, 2013

(30) Foreign Application Priority Data
Feb. 2, 2012 (DE) 202012100357 U1

(51) Int. Cl. F21K 99/00

(52) U.S. Cl. CPC F21K 9/56
USPC 362/231

(57) ABSTRACT

A lamp (11, 21, 61), in particular an LED lamp, has at least one light source (12, 62, 22) and at least one translucent plastic element (13, 23, 63) disposed in the beam path of the at least one lighting means (12, 22, 62). The lamp (24 14) is characterized in that the plastic element (13, 23, 63) comprises at least two plastic layers (13a, 13b; 23a, 23b, 64, 66a, 66b) from different translucent materials, said translucency (T1, T2) of the two plastic layers (13a, 13b; 23a, 23b, 64, 66a, 66b) having a different wavelength dependence such that the overall transmission function of at least one plastic member is changed in a desired manner (63 13, 23).

### RELATED APPLICATIONS

This Application claims priority under 35 U.S.C. §119(a) through (d) of the German Patent Application No. 20 2012 100 357.0 filed Feb. 2, 2012, which is hereby incorporated by reference in its entirety.

### FIELD OF THE INVENTION

The present invention relates to a lamp, in particular an LED lamp having at least one light source and having a translucent plastic member which is arranged in the beam path of light emitted from the at least one light source.

### BACKGROUND OF THE INVENTION

The backlighting of translucent plastic elements, such as push-button caps with backlit icons, with. narrow light sources, such as color LEDs, is easy to control the light transmitted to the eye of a viewer because the color varies only minimally with the wall thickness of the push-button caps. Therefore, the brightness of an LED can be adjusted by varying the wall thickness of the push-button caps.

With a broadband light source such as a white LED, however, it is more complicated. With a broadband light source, both brightness and light color may vary with the wall thickness of the. material covering the light source. Varying the wall thickness of the material covering the light source to produce a homogeneous illumination of the symbol on the covering can vary the color that reaches a viewer's eye. Often move to warmer white translucent materials white light through the material back shades.

FIG. 7 shows an example of the prior art. A conventional lamp 41 comprises a white LED 42 with a white translucent plastic element 43 with constant wall thickness. The plastic element 43 is in the path of the emitted white light 44 of the LED 42. During the passage of the white light 44 by the white plastic element 43, the white light 44 is shifted towards yellow as shown by the arrow 45.

FIG. 8 shows another example of a prior art lamp 51. The lamp 51 comprises a white LED light 52 and white translucent plastic element 53 having a varying thickness (in this figure, wedge-shaped). The plastic element 53 is disposed in the beam path of the emitted white light 54 of the LED 52. The LED 52 is positioned approximately equidistant from the right and left ends of the wedge-shaped plastic element 53, such that the intensity of the emitted white light 54 is approximately the same at each end of the wedge-shaped plastic element 53. When the emitted white light 54 passes through the white translucent plastic element 53, the white light 54 is shifted towards yellow, and does so more the thicker the wall thickness of the white translucent plastic element 53. As indicated by the different gray arrows 55a and 55b, the light 55a emitted through the plastic element 53 at the tip of the wedge is brighter and whiter than the dimmer, yellower light 55b emitted through the plastic element at the stump of the wedge-shaped white translucent plastic element 53, as indicated by the magnitude and shading of the arrows 55a and 55b. Due to the wedge shape, as light passes through the wedge stump more light is absorbed than light passing through the thinner wedge tip, such that the result of the light passing through has different intensities on the wedge stump and wedge tip, as indicated by arrows of different lengths 55a and 55b.

### SUMMARY OF THE INVENTION

In contrast, it is an object of the present invention, to provide a lamp to control the passage of light through the plastic element such that, even with different wall thicknesses of the plastic element, a homogenous color is displayed.

The plastic element comprises two plastic layers of different materials, wherein the translucency of the two layers of plastic have a different wavelength dependence such that the overall transmission function of at least one plastic element is changed in a desired manner, or such that the color shift of the light of the light source passing through the plastic layers takes place in a desired manner.

Preferably, the color shift of the light passing through the at least one plastic element is smaller than the color shift of the light passing through one of the at least two layers of plastic.

According to the invention, the second plastic layer changes the wavelength dependent translucency of the plastic element in such a way that, for example, homogenized in that the light color is shifted to the desired target color. In the white translucent plastic materials of the prior art, shift towards warmer colors can be compensated with the second plastic layer. That the remote, outer plastic layer forms the visible light without passing tag design color the plastic. element, the color of the transmitted light and wavelength dependency of translucency can be optimized through the inner plastic layer.

Where the filter-compensating, the translucency of the two layers of plastic, for example, an opposing wavelength dependence or each opposing have stepped wavelength dependencies.

A further application is the specific color shift by at least one additional plastic layer towards a desired chromaticity. Thus, for example, with just one light source a multi-colored illuminated symbol can be realized. In plain cold design is ideally same for all positions of the plastic element approximation, that the color shift in passing through the two layers of plastic. is constant and leads to the desired target color. This is especially to be calculated thickness profiles for the outer plastic layer (e.g., color keys required) and reaches for the inner plastic layer.

Preferably, the plastic element comprises at least two plastic layers, and can be formed by injection molding.

Preferred embodiments of the invention are the subject of the dependent claims. Further advantages of the invention will be apparent from the Description and the Drawings. Likewise, the above and the following characteristics can be used individually or in any combination. The figures are intended to illustrate the features of the invention. The invention is not to be construed as limited to only the embodiments shown in the figures.

### BRIEF DESCRIPTION OF THE DRAWINGS

FIG. 1 shows a first lamp according to the invention with a double-translucent plastic member wherein the light color of the light passed to the viewer does not change, and preferably is virtually independent of the wavelength of light transmitted through the plastic member.

FIG. 2 shows a second lamp according to the invention with a double-wedge-shaped translucent plastic member wherein the light color of the light passed to the viewer does not change, and preferably is virtually independent of the wavelength of light transmitted through the plastic member.

FIGS. 3a-3c show a first example of the translucency of the type shown in FIG. 1 and FIG. 2 and its two plastic layers (FIGS. 3a, 3b) as a function of wavelength (FIG. 3c).

FIGS. 4a-4c show a second example of the translucency of the type shown in FIG. 1 and FIG. 2 and its two plastic layers (FIGS. 4a, 4b) as a function of wavelength (FIG. 4c).

FIGS. 5a-5c show a third example of the translucency of the type shown in FIG. 1 and FIG. 2 and its two plastic layers (FIGS. 5a, 5c) as a function of wavelength (FIG. 5c).

FIG. 6 shows a further inventive lamp with a key cap in the form of a translucent three-component plastic element.

FIG. 7 is a. lamp according to the prior art with a translucent plastic element, wherein the wavelength of the light emitted to a viewer is dependent on the translucency of the plastic element.

FIG. 8 shows a further lamp according to the prior art with a translucent plastic element, wherein the wavelength of the light emitted to a viewer is dependent on the translucency of the plastic element and varies with thickness of the plastic element.

### DETAILED DESCRIPTION OF THE DRAWINGS

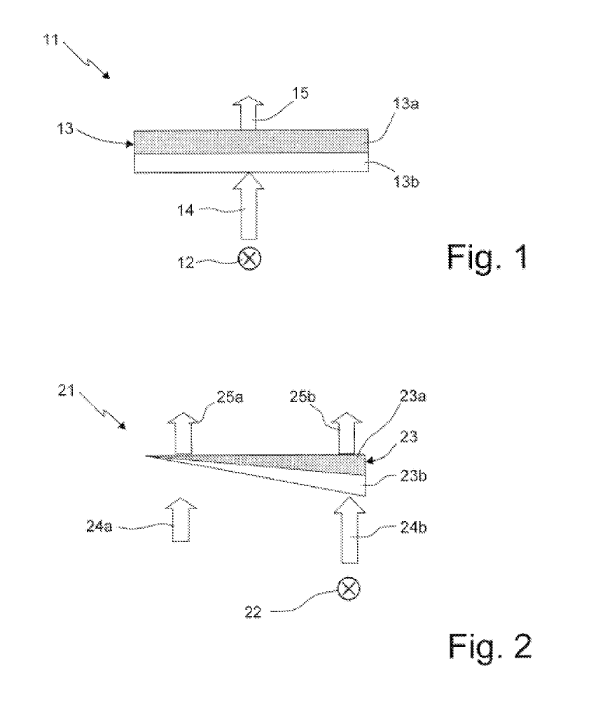

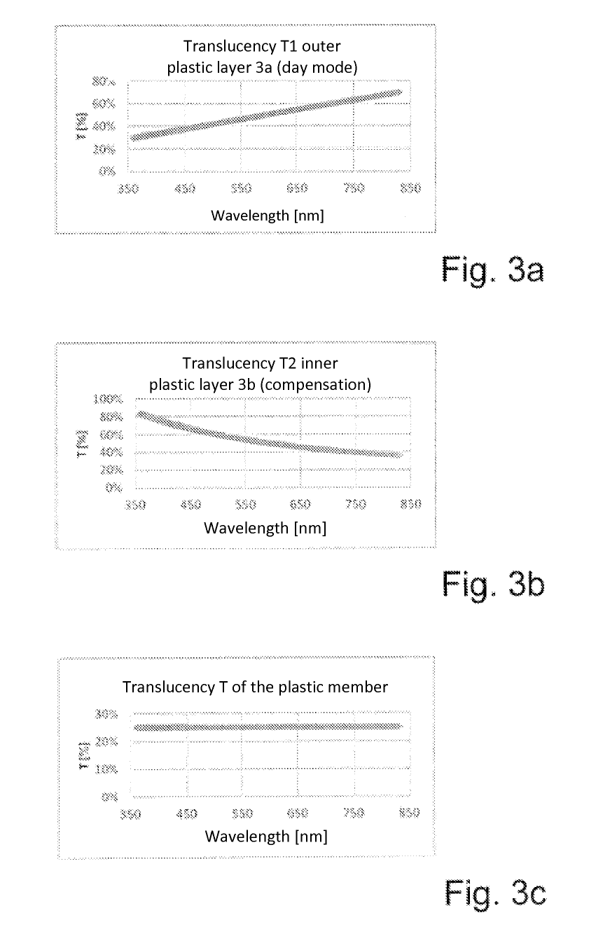

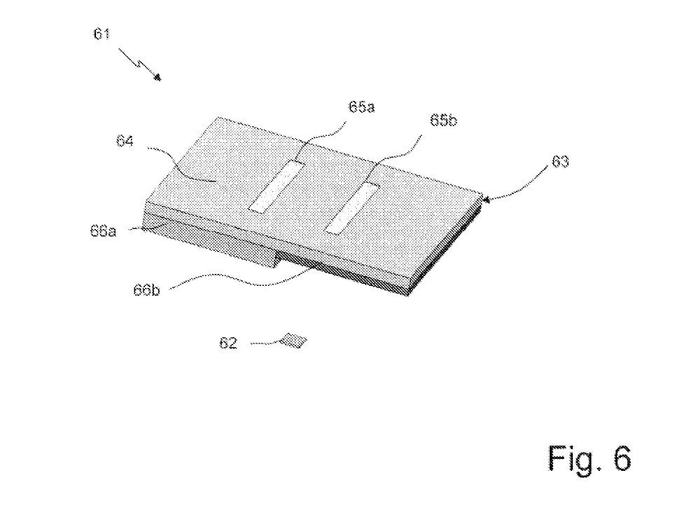

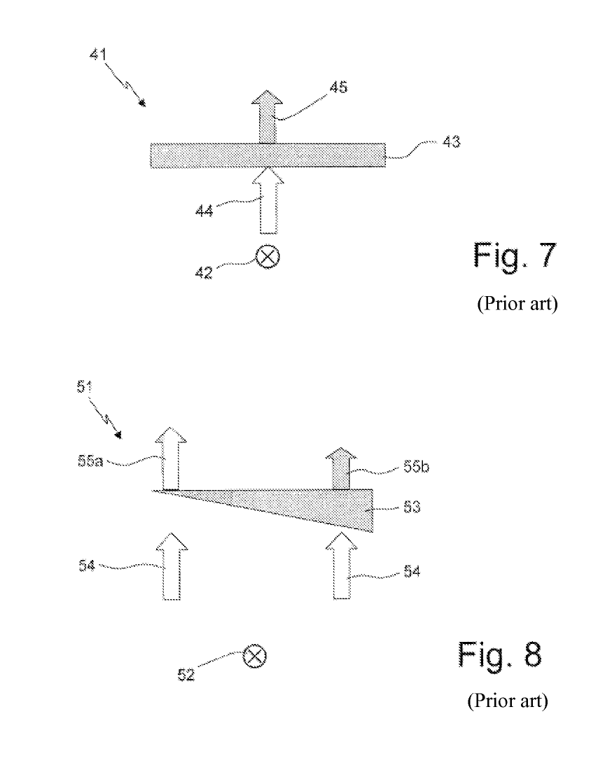

In FIG. 1, a lamp 11 includes a broadband light source, such as white LED 12, and a translucent plastic element 13 with a constant thickness. The plastic element 13, is disposed in the beam path of the emitted white light 14 of the LED 12. The plastic element 13 comprises two plastic layers, 13a and 13b made from materials having different translucency, T1 and T2, respectively. In FIG. 3a, the element 3a refers to the plastic layer 13a from this figure, FIG. 1, the element 23a from FIG. 2, and the element 66a from FIG. 6. In FIG. 3b, the element 3b refers to the plastic layer 13b from this figure, FIG. 1, the element 23b from FIG. 2, and the element 66b from FIG. 6. As shown in FIG. 3a and FIG. 3b, the two plastic layers 3a and 3b have an opposite wavelength dependence. In the remote, outer plastic layer 3a, the translucency T1 increases in as the wavelength increases in the visible range wavelength. The inner plastic layer 3b has translucency T2 that decreases as the wavelength increases in the visible range wavelength. The contrasting wavelength dependencies of the two plastic layers 3a and 3b result in a wavelength-independent translucency T of the translucent plastic member 13, as shown in FIG. 3c. The outer plastic layer 13a is the transmitted light without visible, for example, white or gray tag design color of the plastic member 13, whereas the inner plastic layer 13b, the wavelength dependence of the translucency of the outer plastic layer 13a is compensated and thus prevents a color shift of the passing light 15. During the passage of the white LED light 14 through the plastic element 13 there is no color shift, as indicated by the continuing white arrow 15.

FIG. 2 shows a lamp 21 comprising a white LED light source 22 and a wedge-shaped translucent plastic member 23 that comprises two wedge-shaped plastic layers, 23a and 25b. The plastic member 23 is disposed on the optical path of the emitted white light 24a and 24b from the LED 22. The emitted white light 24a and 24b passes through each of two wedge-shaped plastic layers 23a and 23b. The two wedge-shaped plastic layers 23a and 23b are formed from different translucent materials. Analogous to FIG. 1, the two layers of plastic, 23a and 23b, are of opposite wavelength dependence, as shown in FIGS. 3a and 3b. The thickness of the inner plastic layer 23b increases with the thickness of the outer plastic layer 23a, so that during the passage of the white LED light 24a and 24b by the plastic element 23, no color shift takes place, as indicated by the continuing white arrows 25a and 25b. The LED 22 is closer to the right, thicker end than to the left, thinner end of the plastic member 23 so that the light 24a has a lower intensity at the left end than the intensity of the light 24b incident on the right end, as shown by the shorter arrow 24a and the longer arrow 24b. Due to the wedge shape, as light 24b passes through the right end of the wedge, more light is absorbed as it passes through the plastic element 23 than is absorbed at the thinner wedge tip on the left. As a result, the light 25a and 25b passing through the plastic element 23 has the same intensity at the wedge stump on the right as at the wedge tip on the left, as indicated by the arrows 25a and 25b being of equal length. During the passage of the white LED light 24a and 24b by the wedge-shaped plastic member 23, the intensity of the light passing 25a through the plastic member 23 is thus homogenizing, without a color shift of the light passing through 25a and 25b.

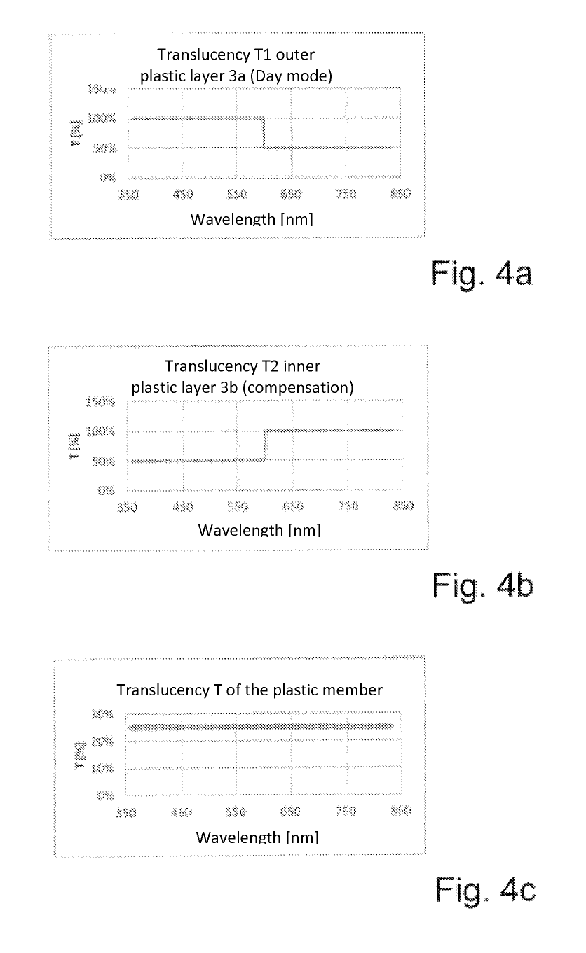

As shown in FIGS. 4a and 4b, the translucency T1 and T2 of the two plastic layers 3a and 3b, respectively, is stepped. By using the opposing wavelength dependencies of translucence T1 and T2, at two plastics layers 3a and 3b, a translucency of the same wavelength is provided. These opposing stepped wavelength dependencies of the two plastic layers 3a and 3b, formed from two compensating filters, result in a wavelength-independent translucency T of the plastic element 3, as shown in FIG. 4c.

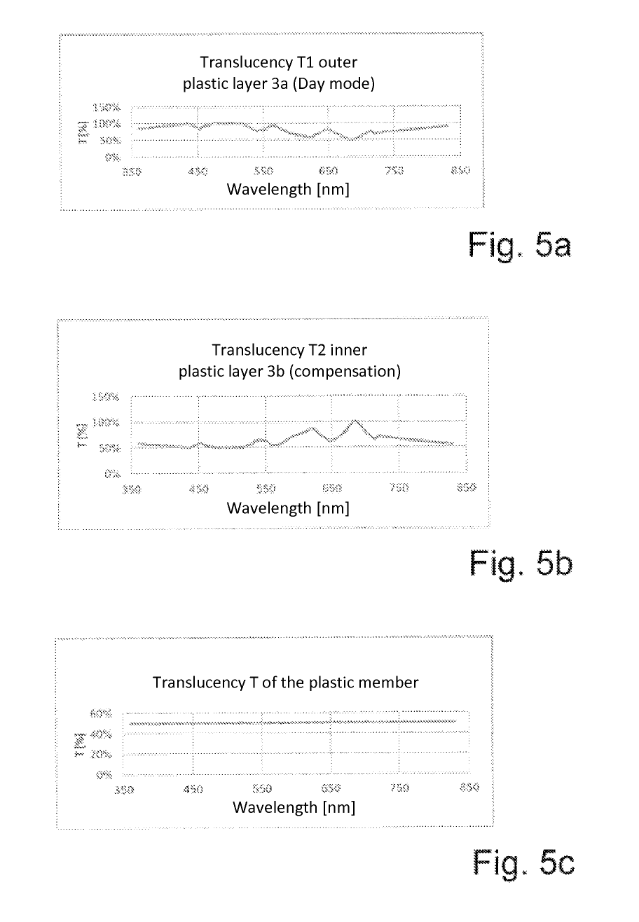

As shown in FIGS. 5a and 5b, the two plastic layers 3a and 3b each have several rising sections and several corresponding failing sections of wavelength dependence. The wavelength dependencies of the two plastic layers 3a and 3 b are approximately mirror images of each other, resulting in a wavelength-independent translucency T of the plastic member 3, as shown in FIG. 5c.

Instead of the shown two layers of plastic, the plastic member, of course, three or more layers of plastic can be formed as a multi-component injection-molded part.

FIG. 6 shows a lamp 61 comprising an LED 62, and a translucent key cap having a three-component plastic element 63. The plastic element 63 is arranged in the beam path of the light emitted from the LED 62. The plastic element 63 comprises an outer translucent plastic layer 64, which is painted on the outside, opaque in a desired color and daylight design, and two non-painted symbol areas 65a and 65b. The plastic member 63 has two differently colored inner translucent plastic layers 66a and 66b, wherein the inner plastic layer 66a behind the inner half of the outer plastic layer 64 that has the symbol 65a. The other plastic. layer 66b is behind the half of the outer plastic layer 64 that has the symbol 65b. The outer plastic layer 64 does not transmit visible light and can be formed, for example, in a white or gray tag design color of the plastic element 63. The inner plastic layers 66a and 66b lead to different colors of screened symbols 65a and 65b, respectively.

What is claimed is:

1. A lamp comprising:
an LED having at least one light source and at least one translucent plastic element disposed in a beam path of the at least one light source, wherein the plastic element comprises at least two plastic layers made from different translucent materials, the translucency T1 and T2 of the at least two plastic layers each having a different wavelength dependence, such that the at least one plastic element has a transmission function and an overall translucency, T, having a wavelength dependence, and such transmission function of the least one plastic member is altered in a desired manner.

2. The lamp according to claim 1, characterized in that the color shift of the light passing through the at least one plastic element is smaller than the color shift of the light passing through one of the at least two plastic layers.

3. The lamp according to claim 1, characterized in that the wavelength dependence of the translucency T of the plastic member is less than the wavelength dependence of the translucency T1 and T2 of each of the at least two plastic layers.

4. The lamp according to claim 1, characterized in that the translucency T1 and T2 of the at least two plastic layers have an opposite wavelength dependence.

5. The lamp according to claim 1, characterized in that the translucency of at least one of the at least two plastic layers has a stepped wavelength dependence.

6. The lamp according to claim 5, characterized in that the translucency T1 and T2 of two of two of the at least two plastic layers each have opposing stepped wavelength interdependence.

7. The lamp according to claim 1, characterized in that the translucency at least one of the at least two plastic layers has both a rising and a falling wavelength dependence.

8. The lamp according claim 1, characterized in that the wave function of the translucency (T) of the plastic element is in the visible range of less than ±5%.

9. The lamp according to claim 1, characterized in that the plastic element with its at least two plastic layers is formed by an injection-molded more components.

10. The lamp according to claim 1, characterized in that the LED comprises a phosphorus converted LED.

11. The lamp according to claim 1, characterized in that the LED comprises an organic light emitting diode (OLED).

12. The lamp according to claim 1, characterized in that the at least one plastic layer comprises an outer layer that is one of white and gray.

13. The lamp according to claim 1, characterized in that at least one plastic layer comprises an outer layer, the outer layer having a thickness that is dependent on a distance from the outer layer to the at least one light source.

14. The lamp according to claim 13, characterized in that at least one plastic layer comprises an inner layer having a thickness that is dependent on one of: the thickness of the outer layer and distance to the at least one light source.
